(19) United States
(12) Patent Application Publication
(10) Pub. No.: US 2017/0063171 A1
(43) Pub. Date: Mar. 2, 2017

(54) Magnetic Radial Engine

(71) Applicants: Shpend Sadiku, Ferizaj (RS); Besnik Haliti, Spring, TX (US)

(72) Inventors: Shpend Sadiku, Ferizaj (RS); Besnik Haliti, Spring, TX (US)

(21) Appl. No.: 14/841,344

(22) Filed: Aug. 31, 2015

(51) Int. Cl. H02K 1/06; H02K 7/075; H02K 7/18; B60K 8/00; H02K 7/102

(52) U.S. Cl. CPC H02K 1/06; B60K 8/00; H02K 7/102; H02K 7/1815; H02K 7/075; H02K 53/00

(57) ABSTRACT

A magnetic radial engine which may comprise a crankshaft assembly, wherein the crankshaft assembly further comprises an output crankshaft assembly and a peripheral crankshaft assembly and a piston assembly, wherein the piston assembly may be connected to the crankshaft assembly and the output crankshaft assembly. Further, comprising an engine ring assembly, an oil system, and a cover, wherein the cover houses the crankshaft assembly, piston assembly, and the oil system.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

Field of the Invention

The field of invention is directed to a radial magnetic engine, and more specifically a radial magnetic engine that uses permanent magnets to rotate an output shaft.

Background of the Invention

An engine converts and/or transfers power into motion. Engines may also be used to convert one form of power into a separate form of power. Gasoline, diesel, steam, electric, compressed air, magnetic, and turbine engines may be used to propel various kinds of vehicles. The range of vehicles may be limited by how much fuel and/or energy may be carried on-board until the next fill-up and/or recharge. Increasing engine efficiencies may improve the range of a vehicle. The more efficient the engine, the greater the range from the same amount of on-board fuel and/or charge. Additionally, the more efficient the engine, the greater amount of power that may be converted from one form to another. As disclosed below, permanent magnets may be used to increase engine efficiencies, which may increase power conversion and range of vehicles.

Permanent magnets may produce a constant magnetic field, while electro-magnets may produce a magnetic field only as long as current may be applied to the electro-magnet. Additionally, the magnitude of the magnetic field may be proportional to the current flowing through the electro-magnet. In embodiments, electric motors may use permanent magnets and electro-magnets in their rotors and stators to turn a rotor, which may produce a mechanical output from an electrical input. Motion may be produced as the magnets are switched on-and-off according to their relative positions, which may allow the magnetic fields to produce rotating torque.

Magnetic fields created by electro-magnets may consume large amounts of energy during operation. Permanent magnets may not require the large amounts of energy to operate. Increasing the use of permanent magnets within engines may increase the efficiency within the engine and may consume less energy during operation.

Consequently, there is a need for a magnetic engine useful for producing electricity and/or mechanical motion. With the increasing demand of cheap energy, an improved magnetic radial engine may be desired to meet the growing demand. The magnetic radial engine of this disclosure may provide the cheap and plentiful power required in a modernized society.

### BRIEF SUMMARY OF SOME OF THE PREFERRED EMBODIMENTS

These and other needs in the art are addressed in an embodiment by a magnetic radial engine which may comprise a crankshaft assembly, wherein the crankshaft assembly further comprises an output crankshaft assembly and a peripheral crankshaft assembly and a piston assembly, wherein the piston assembly may be connected to the crankshaft assembly and the output crankshaft assembly. Further, comprising an engine ring assembly, an oil system, and a cover, wherein the cover houses the crankshaft assembly, piston assembly, and the oil system.

Additionally, a method of operating a magnetic radial engine may comprise releasing a brake pad from an engine ring assembly with a brake control and accelerating an engine ring assembly with a plurality of magnetic fields exerted by a piston assembly. The method may further comprises, moving a piston head back and forth using a plurality of magnetic fields, rotating a peripheral crankshaft assembly, rotating an output crankshaft assembly, and producing electricity by turning an electric generator with the output crankshaft assembly.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such equivalent embodiments do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates an embodiment of a radial magnetic engine;

FIG. 2 illustrates an embodiment of an output crankshaft assembly;

FIG. 3 illustrates an embodiment of a peripheral crankshaft assembly;

FIG. 4 illustrates an embodiment of a piston assembly;

FIG. 5 illustrates an embodiment of a permanent magnet disposed within a piston head;

FIG. 6 illustrates an embodiment of an oil system;

FIG. 7 illustrates an embodiment of an engine ring assembly;

FIG. 8a illustrates an embodiment of piston heads disposed at the greatest distance from each other;

FIG. 8b illustrates a schematic of the magnetic field properties when piston heads are disposed at the greatest distance from each other;

FIG. 9a illustrates an embodiment of piston heads disposed at the closest distance from each other;

FIG. 9b illustrates a schematic of the magnetic field properties when piston heads are disposed at the closest distance from each other

FIG. 10 illustrates a brake housing assembly;

FIG. 11a illustrates a brake pad exerting force upon the engine ring assembly; and

FIG. 11b illustrates a brake pad removed from the engine ring assembly.

### DETAILED DESCRIPTION OF THE PREFERRED EMBODIMENTS

Embodiments relate generally to a radial magnetic engine useful for creating electrical and/or mechanical energy. More particularly, embodiments relate to a cover, a crankshaft assembly, a piston assembly, and an engine ring assembly. In embodiments the crankshaft assembly, piston assembly, and engine ring assembly may operate in conjunction to produce electrical and/or mechanical energy. The radial magnetic energy may allow for the production of cheap and plentiful energy. Current engine technology may rely on an outside fuel source, which may be inefficient due to the combustion of fuel. The fuel for the radial magnetic energy may be in the form of magnetic fields produced by permanent magnets. In embodiments, permanent magnets may help drive and facilitate the production of electrical and mechanical energy.

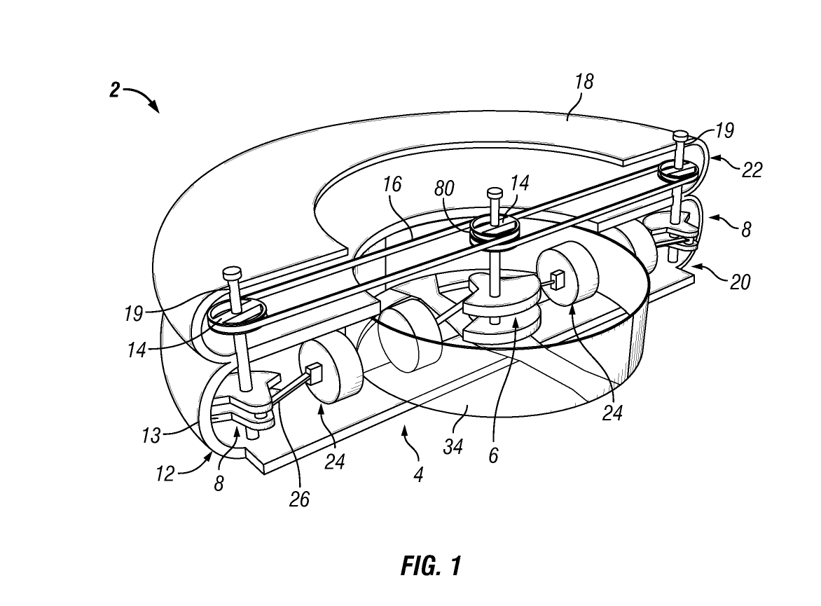

As illustrated in FIG. 1, embodiments of a radial magnetic engine 2 may comprise a structure and method of operation. Radial magnetic engine 2 may produce electricity through an electrical generator, not illustrated, and/or mechanical energy through crankshaft assembly 4. In embodiments, an electrical generator may attach to crankshaft assembly 4 and produce electricity through the rotational movement generated by crankshaft assembly 4. Additionally, mechanical connectors, such as gears and rods (not illustrated), may attach to crankshaft assembly 4 to distribute rotational energy to other mechanical objects (i.e., wheels, pumps, propellers, and the like). In embodiments, crankshaft assembly 4 may comprise an output crankshaft assembly 6 and a peripheral crankshaft assembly 8. Radial magnetic engine 2 may comprise a plurality of output crankshaft assemblies 6 and a plurality of peripheral crankshaft assemblies 8. It is to be understood that all parts of crankshaft assembly 4 may comprise any suitable non-ferrous material and/or plastics. Suitable material may be, but is not limited to, aluminum, copper, lead, nickel, tin, titanium, zinc, brass, gold, silver, neoprene, plastic, rubber, fibers, and/or any combination thereof. Non-ferrous material and/or plastics may not comprise magnetic properties and may not easily magnetized. Without limitations, magnetization may alter and/or prevent movement within radial magnetic engine 2.

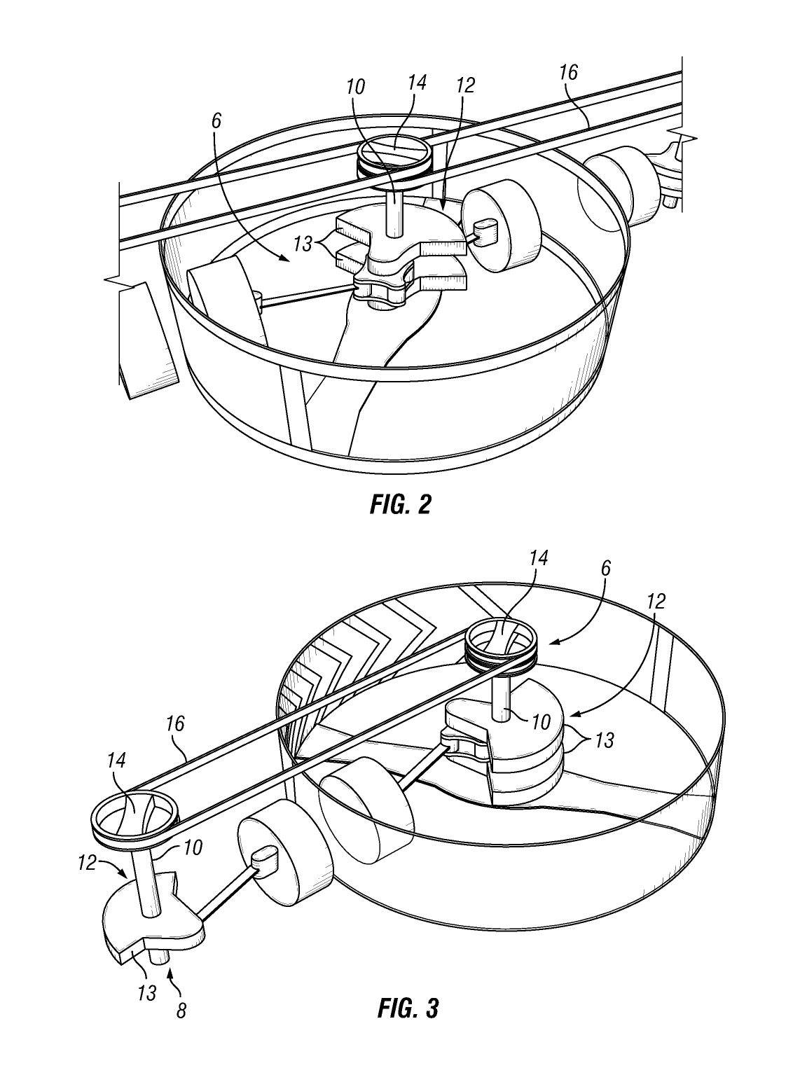

As illustrated in FIGS. 2 and 3, output crankshaft assembly 6 and peripheral crankshaft assembly 8 may comprise a crankshaft 10, balances 12, pulley 14, and belts 16. Output crankshaft assembly 6 may be disposed at about the center of radial magnetic engine 2. Without limitation, a central location for output crankshaft assembly 6 may allow for the most efficient use of energy and rotational motion to be distributed across radial magnetic engine 2. In alternative embodiments, not illustrated, output crankshaft assembly 6 may be disposed at a location not at about the center of radial engine 2. Energy may be transferred from the rotational motion of output crankshaft assembly 6 along crankshaft 10. Crankshaft 10 may comprise a structure of any suitable shape. A suitable shape may be, but is not limited circular, square, polyhedral, and/or any combination thereof. Crankshaft 10 may be any suitable length. A suitable length may be, but is not limited to, about one inch to about sixty inches, about twelve inches to about forty-eight inches, about twenty-four inches to about thirty-six inches, or about six inches to about eighteen inches. In embodiments, crankshaft 10 may be a structure in which balances 12 and pulleys 14 may be disposed. Balances 12 and pulleys 14 may effectively transfer energy through radial magnetic engine 2.

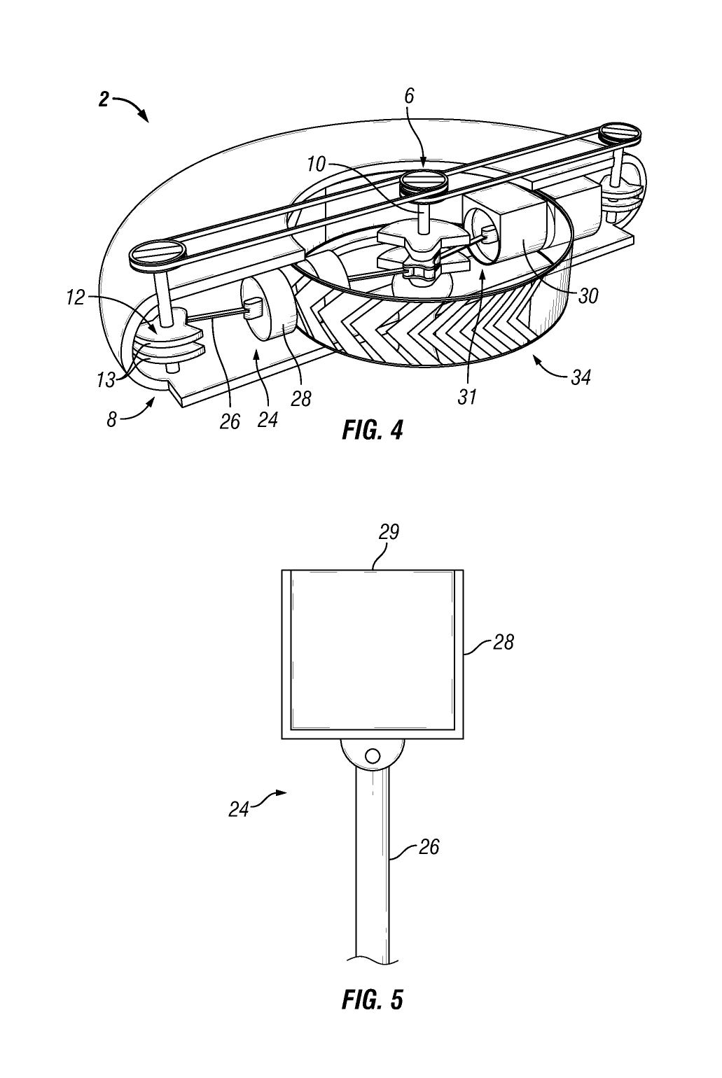

Balances 12, as illustrated in FIGS. 2 and 3, may be parallel lobed plates 13 of any suitable shape. A suitable shape may be, but is not limited to, circular, oval, triangular, square, rectangular, and/or any combination thereof. Balances 12 may attach to crankshaft 10 through any suitable connectors. A suitable connector may be, but is not limited to, a weld, nuts and bolts, adhesive, forming, machined, and/or any combination thereof. As illustrated in FIG. 4, each lobed plate 13 may be connected by a rod 26, described below. The spacing between the two parallel lobed plates 13 may allow for piston assembly 24 to move laterally as crankshaft 10 rotates within radial magnetic engine 2. Balances 12 may be offset in any direction in relation to crankshaft 10. In embodiments, there may be a plurality of balances 12, in which each balance 12 may be offset in a different direction from each other. The balances 12 may be offset by any suitable distance. In embodiments, balances 12 may be offset between about one inch and about six inches, about two inches and about four inches, about three inches and about six inches, or about four inches and about ten inches. Without limitation, offsetting balances 12 may prevent unnecessary vibration and extraneous rotational movement within crankshaft 10. This may allow crankshaft 10 to remain balanced and centered, which may prevent wobbling during rotation. Energy produced from piston assembly 24 may be transferred through balances 12 and into crankshaft 10. Additionally, the rotational energy from crankshaft 10 may be transferred to pulleys 14.

As illustrated in FIGS. 2 and 3, pulleys 14 may transfer rotational energy throughout radial magnetic engine 2. Pulleys 14 may attach to crankshaft 10 through any suitable connectors. A suitable connector may be, but is not limited to, a weld, nuts and bolts, adhesive, forming, machined, and/or any combination thereof. Pulleys 14 may be any suitable shape in which to transfer rotational energy. A suitable shape may be, but is not limited to, circular, oval, polyhedral, and/or any combination thereof. Additionally, pulleys 14 may be any suitable diameter. A suitable diameter may be about one inch to about six inches, about to inches to about four inches, or about three inches to about six inches. As illustrated, rotational energy may be transferred from peripheral crankshaft assembly 8 to output crankshaft assembly 6, or vice versa. In embodiments, there may be a plurality of pulleys 14 disposed within peripheral crankshaft assembly 8 and output crankshaft assembly 6. Pulleys 14 may be disposed at any end of crankshaft 10 and/or between each end of crankshaft 10. As pulley 14 rotates from the rotational movement of crankshaft 10, the rotational energy may be transferred to another pulley 14 through belts 16.

Belts 16, referring to FIG. 1, may transfer rotational energy from one pulley 14 to another pulley 14. That energy may transfer to output crankshaft assembly 6 and/or peripheral crankshaft assembly 8. In embodiments, belts 16 may be any suitable shape. A suitable shape may be, but is not limited to, circular, oval, triangular, square, polyhedral, and/or any combination thereof. Belts 16 may be disposed on pulleys 14 within a groove 80 of pulleys 14. In embodiments, belt 16 may be disposed on at least two pulleys 14 but may be disposed on four pulleys 14. There may be a plurality of belts 16 within radial magnetic engine 2 that may transfer energy between peripheral crankshaft assembly 8 and output crankshaft assembly 6. In embodiments, belts 16 may “time” radial magnetic engine 2. Timing may be defined as the regulation of occurrences, pace, or coordination of components within radial magnetic engine 2. In embodiments, belts 16 may “time” all components within radial magnetic engine 2 to be in the appropriate position at an appropriate time to ensure a functioning and efficient engine. Components of magnetic radial engine 2 may further be protected by cover 18.

As illustrated in FIG. 1, radial magnetic engine 2 may further comprise a cover 18. Cover 18 may form an outer protective layer, which may shield radial magnetic engine 2 from external elements and/or forces. Cover 18 may comprise any suitable non-ferrous material and/or plastics. Suitable material may be, but is not limited to, aluminum, copper, lead, nickel, tin, titanium, zinc, brass, gold, silver, neoprene, plastic, rubber, fibers, and/or any combination thereof. Non-ferrous material and/or plastics may not comprise magnetic properties. Without limitation, magnetization which may alter and/or prevent movement within radial magnetic engine 2. In embodiments, cover 18 may be separated into a lower area 20 and an upper area 22. Lower area 20 may house piston assembly 24, engine ring assembly 34, the lower half of output crankshaft assembly 6, and/or the lower half of peripheral crankshaft assembly 8. Upper area 22 may house the upper half of output crankshaft assembly 6 and/or the upper half of peripheral crankshaft assembly 8. Upper area 22 may separate pulleys 14 and belts 16 from balances 12 and piston assembly 24. Output crankshaft assembly 6 and peripheral crankshaft assembly 9 may traverse and be disposed within both lower area 20 and upper area 22. Additionally, cover 18 may form a structure upon which output crankshaft assembly 6 and peripheral crankshaft assembly 8 may attach. In embodiments, output crankshaft assembly 6 and peripheral crankshaft assembly 8 may pierce cover 18 and may be held in place by a connector 19. Connector 19 may be any suitable connector which may allow output crankshaft assembly 6 and peripheral crankshaft assembly 8 to rotate but may keep output crankshaft assembly 6 and peripheral crankshaft assembly 8 stationary. A suitable connector 19 may be, but is not limited to, ball bearings, ball and socket joint, roller bearings, a grease connection, and/or any combination. Connectors 19 may be disposed within cover 18 at any location in which output crankshaft assembly 6 and peripheral crankshaft assembly 8 may be disposed.

As illustrated in FIG. 1, peripheral crankshaft assemblies 8 may attach to output crankshaft assembly 6 through pulleys 14 and belts 16. In embodiments, there may be at least one piston assembly 24 which may attach to each output crankshaft assembly 6 and peripheral crankshaft assembly 8. In embodiments, the movement of piston assembly 24 may create the rotational energy that may be transferred through radial magnetic engine 2 and may further be transferred to a peripheral device through output crankshaft assembly 6.

As illustrated in FIG. 4, piston assembly 24 may produce sufficient force to rotate crankshaft assembly 4. Piston assembly 24 may comprise a rod 26, piston head 28, and cylinder 30. Radial magnetic engine 2 may comprise a plurality of piston assemblies 24. In embodiments, piston assembly 24 may comprise any suitable non-ferrous material and/or plastics. Suitable material may be, but is not limited to, aluminum, copper, lead, nickel, tin, titanium, zinc, brass, gold, silver, neoprene, plastic, rubber, fibers, and/or any combination thereof. Non-ferrous material and/or plastics may not comprise magnetic properties, which may alter and/or prevent movement within radial magnetic engine 2.

Referring to FIG. 5, piston head 28 may comprise any suitable permanent magnet 29. A suitable permanent magnet 29 may be, but is not limited to, neodymium magnets. Specifically, identified as NdFeB, NIB, and/or Neo Magnet. In embodiments, permanent magnet 29 may comprise a rare-earth magnet, which may comprise an alloy of neodymium, iron, and/or boron. This may form a tetragonal crystalline structure Nd2Fe14B. In embodiments, permanent magnet 29 may be disposed within the body of piston head 28. In embodiments, permanent magnet 29 may be disposed on top, below, and/or along at least one edge of piston head 28. Piston head 28 may be a suitable structure in which permanent magnet 29 may connect. In embodiments, permanent magnet 29 may attach to piston head 28 by any suitable means. Suitable means may be, but are not limited to, forming, machining, threading, welding, adhesive, nuts and bolts, and/or any combination thereof. Additionally, piston head 28 may be any suitable shape. A suitable shape may be, but is not limited to, circular, oval, polyhedral, and/or any combination thereof. In embodiments, piston assembly 24 may attach to crankshaft assembly 4 by rod 26.

Referring to FIGS. 4 and 5, rod 26 may attach to piston head 28 by any suitable connectors. A suitable connector may be, but is not limited to, nuts and bolts, roller bearings, pins, snap rings, and/or any combination thereof. Rod 26 may be disposed at the end of piston head 28 opposite of permanent magnet 29. Additionally, rod 26 may be disposed at an edge of piston head 28 or between both edges of piston head 28. In embodiments, rod 26 may be any suitable shape. A suitable shape may be, but is not limited to, circular, oval, square, triangular, polyhedral, and/or any combination thereof. Additionally, rod 26 may be any suitable length. A suitable length may be about one inch to about twelve inches, about two inches to about ten inches, about four inches to about eight inches, or about six inches to about twelve inches. In embodiments, rod 26 may connect piston head 28 to balance 12. Rod 26 may connect to balance 12 by any suitable connector. A suitable connector may be, but is not limited to, nuts and bolts, roller bearings, pins, snap rings, and/or any combination thereof. This connecter may further connect lobed plates 13 of balance 12. In embodiments, rod 26 may rotate between parallel plates 13 as balance 12 rotates around crankshaft 10. Rod 26 may be disposed between parallel plates 13 at any suitable location, which may allow for efficient movement of rod 26. Specifically, rod 26 may be located about any edge of parallel plates 13 or between any edge of parallel plates 13. The movement of rod 26 may move piston head 28 in a lateral motion within cylinder 30.

As illustrated in FIG. 4, piston head 28 may be disposed within cylinder 30. Cylinder 30 may function to guide piston head 28 in a straight lateral path. This may insure that all force and energy may be directed in an appropriate direction. Cylinder 30 may be any suitable shape. A suitable shape may be circular, oval, square, rectangular, polyhedral, and/or any combination thereof. Cylinder 30 may be disposed at any suitable location of cover 18. Specifically, cylinder 30 may be disposed within lower area 20 about an edge of cover 18 or between both edges of care 18. In embodiments, cylinder 30 may attach to cover 18 by any suitable connectors. A suitable connector may be, but is not limited to, weld, adhesive, nuts and bolts, snap fittings, and/or any combination thereof. Cutout 31, disposed within cylinder 30, may allow for piston head 28 to move within cylinder 30. Cutout 31 may take any shape similar to piston head 28. As piston head 28 moves through cutout 31, friction and heat may build up between piston head 28 and cylinder 30. In embodiments, cylinder 30 may reduce friction and heat through oil system 100.

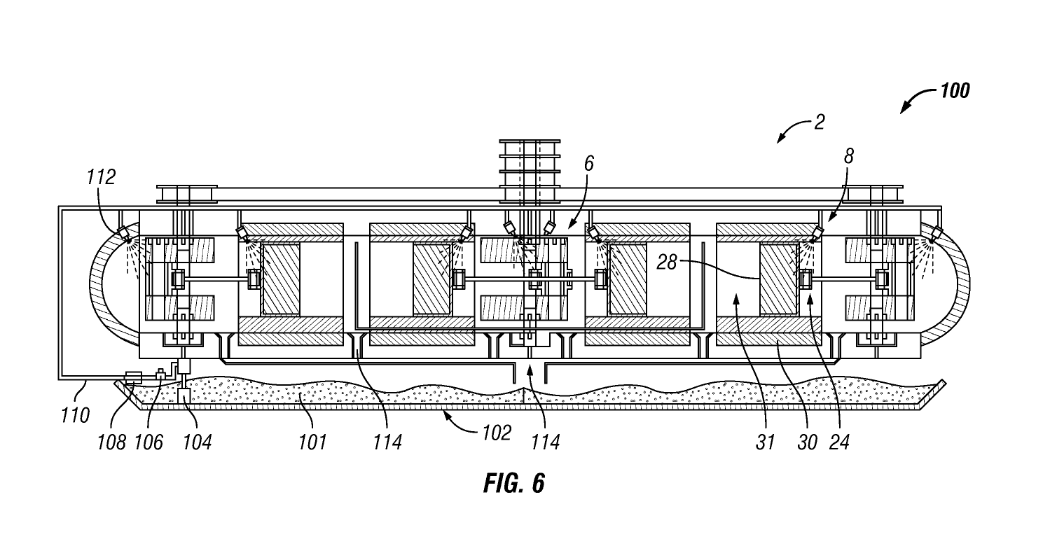

Oil system 100, as illustrated in FIG. 6, may comprise a sump 102, strainer 104, regulator 106, pump 108, line 110, spout 112, and funnel 114. In embodiments, oil system 100 may operate, distribute, and/or recycle any suitable oil 101. Oil 101 may comprise any synthetic, mixture, and/or composition of oils. As illustrated in FIG. 6, oil 101 may be disposed in sump 102. In embodiments, sump 102 may be a lower structure disposed within cover 18 and/or comprise the lower surface of cover 18. Additionally, sump 102 may be a concealed container, which may prevent oil 101 from being removed from sump 102. In embodiments, sump 102 may be disposed above, below, and/or along the sides of radial magnetic engine 2. Oil 101 may be removed from sump 102 and disposed within magnetic radial engine 2 through pump 108.

As illustrated in FIG. 6, pump 108 may be disposed within sump 102. In embodiments, pump 108 may be disposed outside sump 102. Pump 108 may be any suitable regulator know to one of ordinary skill in the art. In embodiments, pump 108 may be mechanically driven by attaching to output crankshaft assembly 6 and/or peripheral crankshaft assembly 8. Additionally, pump 108 may be run on electricity and may draw electricity from an electricity converter, not illustrated, attached to output crankshaft assembly 6. Pump 108 may draw oil 101 from sump 102 at a constant rate, which may be regulated by regulator 106. Additionally, regulator 106 may be any suitable regulator known to one of ordinary skill in the art. In embodiments, regulator 106 may be set at a flow rate for oil 101. The flow rate may prevent excessive amounts of oil from permeating piston assembly 24. In embodiments, regulator 106 may be disposed between pump 108 and sump 102. Regulator 106 may further be disposed within sump 102 and/or outside sump 102. In embodiments, oil 101 may contain contaminants generated from operation of radial magnetic engine 2. Contaminants may clog regulator 106. In embodiments, a strainer 104 may prevent the contaminants from reaching regulator 106 and/or pump 108. Strainer 104 may be disposed within sump 102 and more specifically within oil 101. In embodiments, strainer 104 may comprise any steel, plastic, and/or wire mesh. Additionally, the mesh may be porous to allow oil 101 to flow through but may prevent larger contaminants from passing through. Oil 101 may be removed from sump 102, filtered by strainer 104, and transported through radial magnetic engine 2 by line 110. In embodiments, there may be a plurality of lines 110 that transport oil 101 throughout radial magnetic engine 2. Lines 110 may comprise any suitable tubular material for transporting oil 101. Suitable material may be, but is not limited to, stainless steel, plastic, alloys, metals, and/or any combination thereof. Lines 110 may transport oil 101 from sump 102 to spout 112. In embodiments there may be a plurality of spouts 112 which may deliver oil 101 to different areas of radial magnetic engine 2. Spouts 112 may be disposed to deliver oil 101 at a constant rate to output crankshaft assembly 6, peripheral crankshaft assembly 8, and/or piston assembly 24. In embodiments, spouts 112 may be disposed above, below, and/or at least one edge of output crankshaft assembly 6, peripheral crankshaft assembly 8, and/or piston assembly 24. Oil 101 may be disposed between piston head 28 and cylinder 30, which may prevent friction and heat. Additionally, oil 101 may be disposed on moving parts in output crankshaft assembly 6 and/or peripheral crankshaft assembly 8, which may further prevent friction and heat. During operation, oil 101 may be pulled by gravity toward sump 102. In embodiments, funnels 114 may direct oil 101 back into sump 102, where oil 101 may be recycled and reused. Funnels 114 may be disposed below and/or at a side of output crankshaft assembly 6, peripheral crankshaft assembly 8, and/or piston assembly 24. Oil 101 may allow for the efficient and smooth operation of piston assembly 24.

As illustrated in FIGS. 4 and 7, engine ring assembly 34 may separate piston assemblies 24. Referring to FIG. 7, engine ring assembly 34 may comprise any suitable metal. A suitable material may be, but is not limited to, plastic, metal, aluminum, stainless, steel, neodymium, and/or any combination thereof. In embodiments, engine ring assembly 34 may be any suitable shape. A suitable shape may be circular, oval, polyhedral, and/or any combination thereof. Additionally, engine ring assembly 34 may be disposed about the center of radial magnetic engine 2. In embodiments, engine ring assembly 34 may attach to output crankshaft assembly 6 through supports 36. Supports 36 may be disposed at any suitable location on engine ring assembly 34 and may attach to output crankshaft assembly 6. In embodiments, supports 36 may attach to engine ring assembly 34 and output crankshaft assembly 6 by welds, nuts and bolts, formed, manufactured, adhesive, and/or any combination thereof. In embodiments, engine ring assembly 34 may rotate with crankshaft 10. The rotation of crankshaft 10 may manipulate permeant magnets 29 of piston assemblies 24. Specifically, half of engine ring assembly 34 may not comprise magnetic properties and the other half may comprise areas where magnetic properties may be weak in one area and strong in another area. In embodiments, section 82 may have no magnetic properties, section 84 may have weak magnetic properties, and section 86 may have strong magnetic properties.

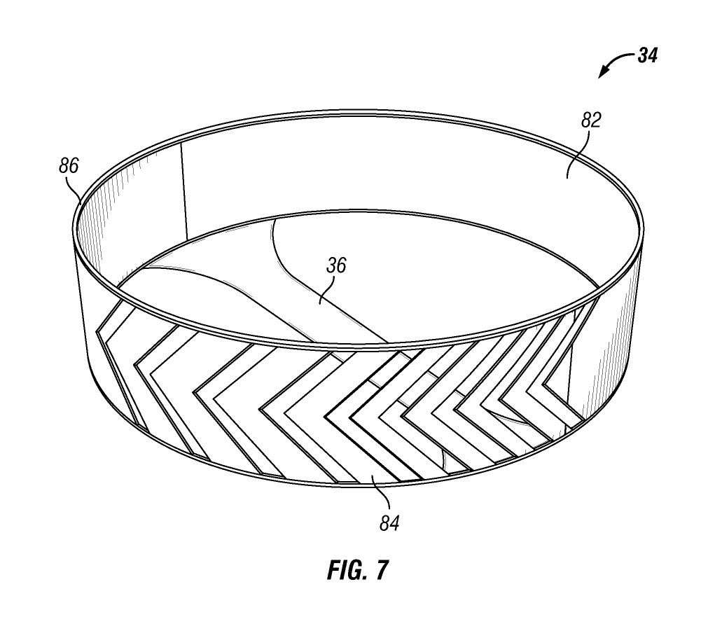

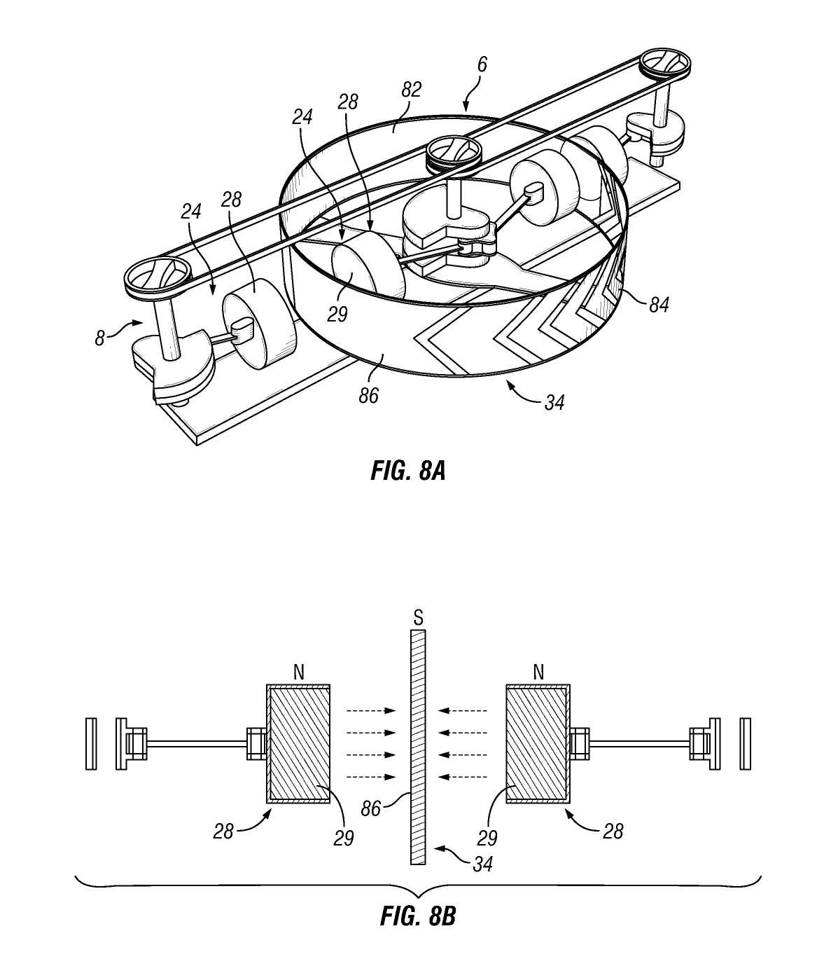

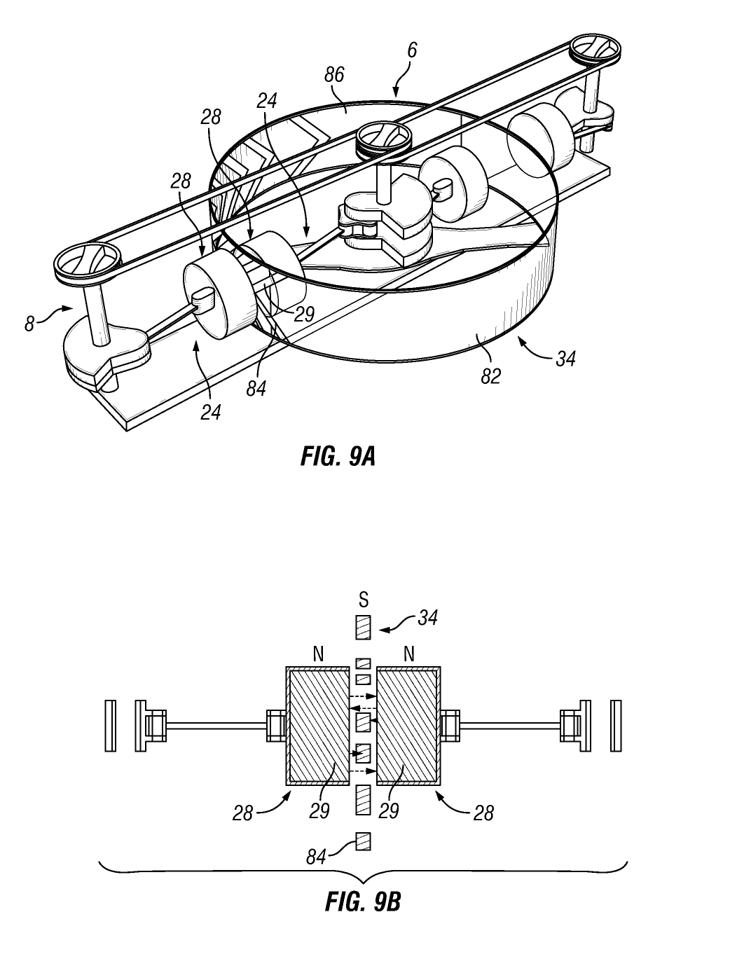

As illustrated in FIGS. 8a, 8b, 9a, and 9b, the movement of piston assembly 24 and thus radial magnetic engine 2 may be controlled and timed by engine ring assembly 34. Specifically, FIG. 8a illustrates a set point when two piston assemblies 24 may be disposed at the greatest distance from each other. Section 86 of engine ring assembly 34 may be disposed between both piston assemblies 24. In embodiments, each piston head 28 may comprise permanent magnet 29 with a “North” magnetic field. This may cause each piston head 28 to repel from each other, which may cause piston heads 28 to move in opposite direction, and thus rotate output crankshaft assembly 6, peripheral crankshaft assembly 8, and/or piston assembly 24. As illustrated in FIGS. 8a and 8b, section 84 may produce a strong “South” magnetic field. The “South” magnetic field may overcome the repulsive force felt by each permanent magnet 29 within piston assemblies 24. This may attract piston heads 28 toward engine ring assembly 34, which in turn may continue to rotate output crankshaft assembly 6, peripheral crankshaft assembly 8, and/or piston assembly 24. The rotation of output crankshaft assembly 6 may rotate engine ring assembly 34. As engine ring assembly 34 rotates, the magnetic properties of engine ring assembly 34 may rotate with engine ring assembly 34.

As illustrated in FIGS. 9a and 9b, engine ring assembly 34 has rotated where section 84 may be disposed between two piston assemblies 24. Section 84 may have weak “South” magnetic properties. At this point in the rotation cycle, the attraction between section 86 may have caused both piston heads 28 to be disposed at the closest distance from each other. A weaker “South” magnetic field in section 84 may cause each piston head 28 to react to the opposite “North” magnetic field of the opposite permanent magnet 29. The repulsion of two magnetic “North” fields may cause piston heads 28 to move away from each other. This may further rotate output crankshaft assembly 6, peripheral crankshaft assembly 8, and/or piston assembly 24. As piston heads 28 repel from each other, section 82 of engine ring assembly 34 may be disposed between two piston assemblies 24. The lack of magnetic properties in section 82 may allow for the magnetic field of piston heads 28 to fully repel each other to a distance wherein both piston heads 28 may be disposed at the largest distance from each other. The movement of piston assemblies 24 and engine ring assembly 34 maybe constantly repeated, which may rotate output crankshaft assembly 6 and peripheral crankshaft assembly 8. Rotation of output crankshaft assembly 6 may run an electric generator and/or mechanical objects.

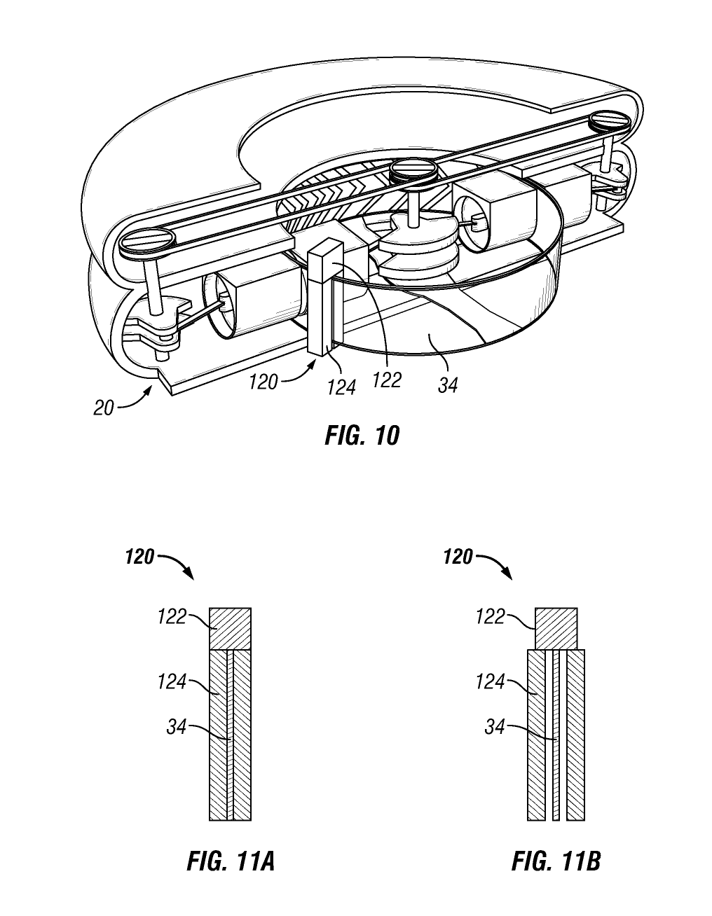

The rotation of radial magnetic engine 2 may be controlled by brake housing 120. Referring to FIG. 10, brake housing 120 may be dispose around engine ring assembly 34. Additionally, brake housing 120 may be disposed at any suitable location within lower area 20. Brake housing 120 may attach to lower area 20 by any suitable means. Suitable means may be, but are not limited to, weld, forming, nuts and bolts, screws, adhesive, brackets, and/or any combination thereof. Brake housing 120 may comprise brake controls 122 and brake pads 124. Brake controls 122 may be disposed at the top of brake housing 120. In embodiments, brake controls 122 may be disposed about an edge and/or about the bottom of brake housing 120. Brake controls 122 may control the movement of brake pads 124. Brake controls 122 may be hydraulically operated. Additionally, brake controls 122 may be mechanically operated and/or electrically operated. Motors, servos, electronics, and control circuits, not illustrated, may be housed within brake controls 122. These components may provide functionality to brake housing 120, which may allow for the movement of brake pads 124.

As illustrated in FIGS. 11a and 11b, brake pads 124 may move closer and further away from engine ring assembly 34. In embodiments, brake pads 124 may traverse the vertical length of engine ring assembly 34. Brake pads 124 may further traverse the vertical length of engine ring assembly 34 partially. Additionally, brake pads 124 may comprise any suitable material in which to stop engine ring assembly 34 from rotating. Suitable material may be, but is not limited to, cloth, plastic, ceramic, metal, felt, and/or any combination thereof. Referring to FIG. 11a, brake controls 122 may dispose brake pads 124 to contact engine ring assembly 34. Brake pads 124 may apply pressure from opposite side. In embodiments, there may be a single brake pad 124, which may only apply pressure to one side of engine ring assembly 34. The force exerted upon engine ring assembly 34 by brake pads 124 may prevent the movement of engine ring assembly 34, which may further prevent the rotation of radial magnetic engine 2. Referring to FIG. 11b, brake controls 122 may remove brake pads 124 from engine ring assembly 34, which may dispose brake pads 124 adjacent but not touching engine ring assembly 34. This may allow engine ring assembly 34 to rotate. Free to rotate, engine ring assembly 34 may begin to rotate again as magnetic fields produced from piston assembly 24 drive piston heads 28. The application of brake pads 124 may stop, slow, and/or accelerate magnetic radial engine 2.

Although the present invention and its advantages have been described in detail, it should be understood that various changes, substitutions and alterations may be made herein without departing from the spirit and scope of the invention as defined by the appended claims.

What is claimed is:

1. A magnetic radial engine comprising:
a crankshaft assembly, wherein the crankshaft assembly further comprises an output crankshaft assembly and a peripheral crankshaft assembly;
at least one piston assembly, wherein the at least one piston assembly is connected to the crankshaft assembly and the output crankshaft assembly;
an engine ring assembly;
an oil system; and
a cover, wherein the cover houses the crankshaft assembly, the at least one piston assembly, and the oil system.

2. The magnetic radial engine of claim 1, wherein the output crankshaft assembly further comprises a crankshaft, at least one balance, and at least one pulley.

3. The magnetic radial engine of claim 2, wherein the at least one balance comprises two parallel plates, wherein the parallel plates are connected by a rod, and wherein the piston assembly connects to the parallel plates through the rod.

4. The magnetic radial engine of claim 2, wherein the output crankshaft is connected to an electric generator or a mechanical device.

5. The magnetic radial engine of claim 2, wherein the at least one pulley is connected to an edge of the crankshaft.

6. The magnetic radial engine of claim 1, wherein the peripheral crankshaft assembly further comprises a crankshaft, at least one balance, and at least one pulley.

7. The magnetic radial engine of claim 6, wherein the at least one balance comprises two parallel plates, wherein the parallel plates are connected by a rod, and wherein the piston assembly connects to the parallel plates through the rod.

8. The magnetic radial engine of claim 6, wherein the output crankshaft is connected to an electric generator or a mechanical device.

9. The magnetic radial engine of claim 6, wherein the at least one pulley is connected to an edge of the crankshaft.

10. The magnetic radial engine of claim 1, wherein the engine ring assembly comprise an area of non-magnetic properties, an area of with strong magnetic properties, and an area with weak magnetic properties.

11. A method of operating a magnetic radial engine comprising:
releasing a brake pad from an engine ring assembly with a brake control;
accelerating an engine ring assembly with a plurality of magnetic fields exerted by a piston assembly;
moving a piston head back and forth using a plurality of magnetic fields;
rotating a peripheral crankshaft assembly;
rotating an output crankshaft assembly; and
producing electricity by turning an electric generator with the output crankshaft assembly.

12. The method of claim 11, further comprising applying the brake pad to the engine ring assembly to slow the rotation of the engine ring assembly.

13. The method of claim 11, wherein the engine ring assembly comprise a magnetic area and a non-magnetic area.

14. The method of claim 13, wherein the non-magnetic area allow for the magnetic fields to push against each other.

15. The method of claim 14, wherein the piston head moves from the repulsion experienced from the magnetic fields away from the engine ring assembly.

16. The method of claim 13, wherein the magnetic area attracts the magnetic fields toward the engine ring assembly.

17. The method of claim 16, wherein the piston head moves from the attraction experienced from the magnetic fields toward the engine ring assembly.

18. The method of claim 11, wherein the piston head further comprises a permanent magnet disposed at the top of the piston head.

19. The method of claim 18, wherein the permanent magnet comprises neodymium.

20. The method of claim 11, further comprising turning a plurality of mechanical gears with the outputs crankshaft assembly to provide motion to a vehicle.
